(19) United States
(12) Patent Application Publication
(10) Pub. No.: US 2024/0367679 A1
(43) Pub. Date: Nov. 7, 2024

(54) SYSTEMS AND METHODS FOR MOBILE DEVICE MOVEMENT

(71) Applicant: APPLE INC., Cupertino, CA (US)

(72) Inventor: Libo Cao Meyers, San Jose, CA (US)

(21) Appl. No.: 18/688,690

(22) PCT Filed: Aug. 30, 2022
(86) PCT No.: PCT/US22/41989

§ 371 Date: Mar. 1, 2024

Related U.S. Application Data
(60) Provisional application No. 63/240,234, filed on Sep. 2, 2021.

(51) Int. Cl. B60W 60/00; B60W 50/02

(52) U.S. Cl. CPC B60W 60/001; B60W 50/0205; B60W 2050/021; B60W 2556/45; B60W 2756/10

(57) ABSTRACT

In one implementation, a communication is received at a first mobile device (102) from a second mobile device (104). The first mobile (102) device is experiencing a perception issue. A follow mode is initiated in response to receipt of the communication from the second mobile device (104) at the first mobile device (102). The follow mode corresponds to a travel path from a current geographical location of the first mobile device to a destination location. External motion data is received from the second mobile device at the first mobile device in connection with the follow mode. The external motion data is obtained by the second mobile device (104) as the second mobile device moves along the travel path. The first mobile device (102) moves along the travel path (106) by generating a motion plan using the external motion data.

### CROSS-REFERENCE TO RELATED APPLICATION

The present application claims priority to U.S. Provisional Patent Application No. 63/240,234, filed on Sep. 2, 2021, which is incorporated by reference in its entirety herein.

### FIELD

Aspects of the present disclosure relate to systems and methods for assisting mobile device movement and more particularly to initiating a follow mode for a first mobile device to follow a second mobile device.

### BACKGROUND

A mobile device may include one or more sensors to capture information within a field of view of the mobile device. Such information may be used to detect objects within the field of view for the mobile device to consider during motion planning and execution. However, in some situations, the mobile device may experience an issue in capturing or processing such information.

### SUMMARY

Implementations described and claimed herein address the foregoing by providing systems and methods for mobile device movement. In one implementation, a communication is received at a first mobile device from a second mobile device. The second mobile device is disposed in a vicinity of a current geographical location of the first mobile device, and the first mobile device is experiencing a perception issue. A follow mode is initiated in accordance with receipt of the communication from the second mobile device at the first mobile device. The follow mode corresponds to a travel path from the current geographical location of the first mobile device to a destination location. External motion data is received from the second mobile device at the first mobile device in connection with the follow mode. The external motion data is obtained by the second mobile device as the second mobile device moves along the travel path. The first mobile device autonomously moves along the travel path by generating a motion plan using the external motion data.

In another implementation, a sensor system has at least one sensor configured to capture sensor data corresponding to a field of view of a first mobile device. A perception system is configured to generate perception data using the sensor data. At least one of the sensor system or the perception system is experiencing a perception issue. The first mobile device receives a communication from a second mobile device disposed in the vicinity of a current geographical location of the first mobile device. The communication corresponds to the perception issue. A follow mode between the first mobile device and the second mobile device is initiated in accordance with receipt of the communication from the second mobile device. The follow mode corresponds to a travel path from the current geographical location of the first mobile device to a destination location. A motion planner is configured to receive external motion data from the second mobile device at the first mobile device in connection with the follow mode. The external motion data is obtained by the first mobile device as the second mobile device moves along the travel path. The motion planner is configured to generate a motion plan using the external motion data for autonomously moving the first mobile device along the travel path.

In another implementation, a follow request for a first mobile device is received at a second mobile device. The follow request corresponds to a maintenance issue of the first mobile device. A communication is sent to the first mobile device when the second mobile device is disposed in a vicinity of a current geographical location of the first mobile device, and a follow mode is initiated based on the communication with the first mobile device. The follow mode corresponds to a travel path from the current geographical location of the first mobile device to a destination location. The first mobile device is directed along the travel path by sending external motion data from the second mobile device to the first mobile device in connection with the follow mode. The external motion data is obtained by the second mobile device as the second mobile device moves along the travel path. The first mobile device autonomously moves along the travel path by generating a motion plan using the external motion data.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example environment for mobile device movement.

FIG. 2 is a block diagram of an example mobile device.

FIG. 3 illustrates example operations for mobile device movement.

FIG. 4 illustrates other example operations for mobile device movement.

FIG. 5 is a functional block diagram of an electronic device including operational units arranged to perform various operations of the presently disclosed technology.

FIG. 6 is an example computing system that may implement various aspects of the presently disclosed technology.

### DETAILED DESCRIPTION

Aspects of the presently disclosed technology relate to systems and methods for directing or otherwise assisting with mobile device movement. In one aspect, a first mobile device is experiencing a perception issue, such that a confidence of the first mobile device in motion planning is suboptimal, for example, below a confidence threshold. The first mobile device generates a follow request in response to detecting the perception issue. Based on the follow request, a follow mode may be initiated between the first mobile device and a second mobile device disposed in a vicinity of a current geographical location of the first mobile device. The follow mode corresponds to a travel path from the current geographical location of the first mobile device to a destination location, such as a maintenance location, a storage location, a parking location, a charging location, a home location, and/or the like. The second mobile device communicates motion data to the first mobile device as the second mobile device moves along the travel path, and the first mobile device autonomously moves along the travel path by generating a motion plan using the external motion data.

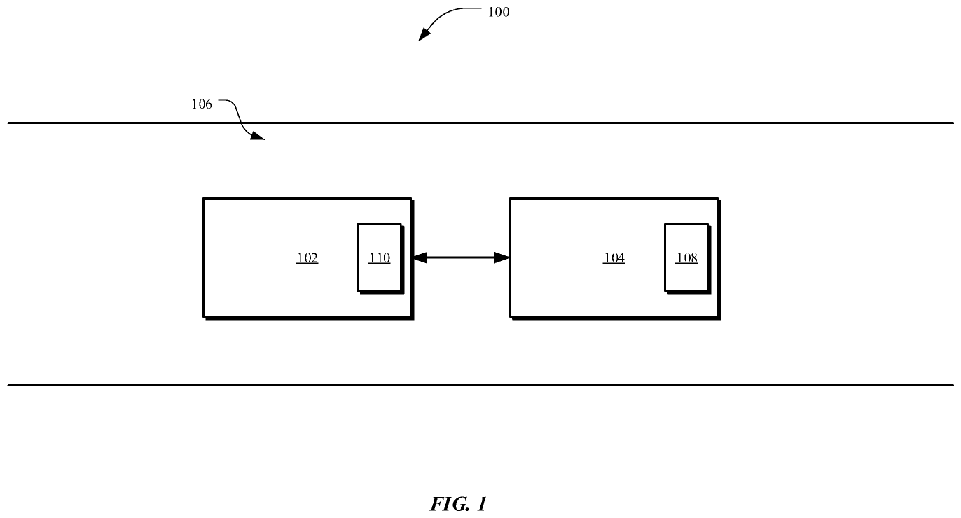

To begin a detailed description of an example environment 100 for mobile device movement, reference is made to FIG. 1. In one implementation, a first mobile device 102 is disposed at a current geographical location within a geographical area.

In one example, the first mobile device 102 is configured to autonomously move along a travel path, such as a route or other movement path. The first mobile device 102 may be capable of operating to move along the travel path with limited input from a person, such as occupants within an interior of the first mobile device 102. Stated differently, rather than a person having an operational engagement with the first mobile device 102 to control its actions, the person may simply input a destination point or other instruction and the first mobile device 102 transports the occupant to the destination point through a series of autonomous decisions. Using localization data, the current geographical position of the first mobile device 102 within the geographical area and/or relative to the destination point or other location may be determined. Using the localization data, the travel path from the current geographical position to the destination point may be generated, a position along the travel path may be determined, and/or the like. Additionally, depending on their nature and movement, one or more objects present in a scene along the travel path may or may not impact the actions being executed by the first mobile device 102 as it moves through the scene. In one implementation, the first mobile device 102 regularly captures sensor data of the scene to generate perception data providing a perception of the scene, which may include, without limitation, object recognition of the one or more objects present in the scene. The object recognition may include detection, identification, classification, determining, localization, and/or the like of the one or more objects present in the scene. Using the localization data and the perception data, the first mobile device 102 executes motion planning for autonomously moving along the travel path through the scene.

There may be instances where the first mobile device 102 is experiencing a perception issue. For example, the perception issue may correspond to and/or contribute to a sensor imaging issue, a sensor data capture issue, a perception data generation issue, a localization issue, a planning issue, and/or the like. For example, a sensor of the first mobile device 102 may qualify for maintenance, replacement, or upgrade. In another example, a localization system (e.g., a global navigation satellite system (GNSS)) of the first mobile device 102 may have a connection or other issue impacting localization of the first mobile device 102 within the geographic area. In instances where a perception issue is present, motion planning by the first mobile device 102 may be suboptimal. The perception issue may be automatically detected by the first mobile device 102. Upon detection of the perception issue, the first mobile device 102 may notify a user, prompt a user for manual control, move to a safe location for stopping, prevent further autonomous movement of the first mobile device 102, and/or the like. As such, in one example, the first mobile device 102 may be stopped at the current geographical location. Such issues may be referred to as sensor perception issues.

In one implementation, the first mobile device 102 or other computing device associated with the user of the first mobile device 102 (e.g., a smartphone) may generate a follow request in response to detection of the perception issue. The follow request may be automatically or manually generated in response to the detection of the perception issue. For example, the first mobile device 102 may automatically generate and transmit the follow request in response to detection of the perception issue. As another example, the first mobile device 102 may detect the perception issue and prompt a user to send the follow request. The follow request may include the current geographical location of the first mobile device 102, a follow window, a destination location, and/or the like.

The follow window may specify a time period for moving the first mobile device 102 from the current geographical location to the destination location. The time period may be a current time period or a future time period. For example, the time period may be the current time period to move the first mobile device 102 from the current geographical location to the destination location in near real time. The future time period may correspond to a first available time period or a scheduled time period. For example, the follow window may specify the first available time period to move the first mobile device 102 from the current geographical location to the destination location as soon as possible. The scheduled time period may be used to schedule a window for the first mobile device 102 from the current geographical location to the destination location according to the schedule of the user, an operator of the destination location, and/or an availability of a second mobile device 104 for responding to the follow request. The follow window may be automatically scheduled or manually scheduled. In one example, the follow window is automatically scheduled and the user is automatically presented with a notification including the follow window. The notification may further include an estimated time of arrival at the destination location, an estimated time that the first mobile device 102 will return to the current geographical location if applicable, and/or the like. In another example, the user is prompted to schedule the follow window.

The destination location may correspond to a maintenance location, a storage location, a parking location, a charging location, a home location, and/or the like. At the destination location, the perception issue may be resolved or otherwise addressed automatically or manually. For example, hardware associated with the perception issue may be replaced, repaired, upgraded, and/or the like. In another example, software of the first mobile device 102 may be upgraded or otherwise optimized to resolve or otherwise address the perception issue. The software optimization may be performed via wired or wireless connection (e.g., software may be communicated from a charging station).

The follow request may be transmitted to one or more mobile devices located within a vicinity of the first mobile device 102, a central server, and/or the like. For example, the follow request may be broadcast within the vicinity of the current geographical location of the first mobile device 102. The second mobile device 104 may be located in the vicinity of the current geographical location of the first mobile device 102 (e.g., within a range of the broadcast) and respond to the follow request with a communication. The second mobile device 104 is one of a plurality of mobile devices located in the geographical location of the first mobile device 102. The second mobile device 104 may be selected from the plurality of mobile devices based on the follow window, the destination location, proximity to the first mobile device 102, availability of the second mobile device 102, and/or the like. In some examples, whether one device is within a vicinity of another device is determined using a threshold distance, such that devices within the threshold distance of each other are considered to be within a vicinity of each other.

In another example, the follow request may be sent to a central server from the first mobile device 102 or a computing device associated with the user and/or the first mobile device 102 (e.g., a smartphone). The central server may select and deploy the second mobile device 104 to the current geographical location of the first mobile device 102. The second mobile device 104 may be deployed to the current geographical location of the first mobile device 102 from a remote location. In one example, the second mobile device 104 autonomous navigates from the remote location to the vicinity of the current geographical location of the first mobile device 102 based on the follow request. In another example, the second mobile device 104 is shipped to the current location of the first mobile device 102 or another specified location. In yet another example, the second mobile device 104 is deployed from a storage location (e.g., a location within the first mobile device 102). Stated differently, the second mobile device 104 may be an accessory that is associated with the first mobile device 102 and that may be deployed in response to the follow request or otherwise as prompted by the first mobile device 102.

Each of the first mobile device 102 and the second mobile device 104 may be an autonomous machine, such as a robot or an autonomous vehicle including, without limitation, an unmanned aerial vehicles (UAV); manned or unmanned terrestrial vehicles, aerial vehicles, aerospace vehicles, passenger vehicles, submersible vehicles, long-haul trucks, and/or the like. In some examples, the second mobile device 104 is a motion assistant in the form of a computing device that may be mounted to the first mobile device 102 or otherwise deployed in response to the follow request.

When the second mobile device 104 is disposed in the vicinity of the first mobile device 102, the second mobile device 104 and the first mobile device may communicate according to a communication protocol. For example, the first mobile device 102 and the second mobile device 104 may communicate via vehicle-to-vehicle (V2V) communication and/or other wired or wireless communication. The first mobile device 102 may receive a communication from the second mobile device 104 when the second mobile device 104 is disposed within the vicinity of the current geographical location of the first mobile device 102. The communication may form part of a communication exchange establishing that the second mobile device 104 is a trusted device. It will be appreciated that the second mobile device 104 may be established as a trusted device in a variety of manners. The destination location may be included in the follow request or otherwise communicated to the second mobile device 104. In response to the receipt of the communication from the second mobile device 104 or upon detection of the second mobile device 104 in the vicinity of the current geographical location of the first mobile device 102, a follow mode may be initiated.

The follow mode may correspond to a travel path 106 from the current geographical location of the first mobile device 102 to the destination location. In the follow mode, the first mobile device 102 and the second mobile device 104 may be disposed in a follow relationship. The follow relationship includes the second mobile device 104 being disposed relative to the first mobile device 102, such that the second mobile device 104 is capable of directing or otherwise assisting with movement of the first mobile device 102. The follow relationship may include the second mobile device 104 disposed in front of the first mobile device 102, above the first mobile device 102, mounted to the first mobile device 102, and/or the like.

In connection with the follow mode, in one implementation, the second mobile device 104 captures external motion data 108 corresponding to a field of view of its sensors. The field of view of the second mobile device 104 may encompass at least a portion of a 360° area around the second mobile device 104. In some examples, the field of view of the second mobile device 104 is directed towards a front of the second mobile device 104 as it moves along the travel path 106. Various objects be located within the field of view.

The external motion data 108 may include external sensor data, external perception data, external localization data, external motion planning data, and/or the like. The external motion data 108 may be captured as the second mobile device 104 moves along the travel path 106. The second mobile device 104 may capture the external motion data 108 corresponding to the field of view of its sensors or otherwise based on the follow relationship. For example, the external sensor data may be captured using one or more sensors of the second mobile device 104. The external sensor data is captured of the field of view of the second mobile device 104 and corresponds to the field of view of the first mobile device 102, such that the first mobile device 102 may use the external sensor data to supplement or replace its sensor data. In another example, the external localization data may correspond to a location of the second mobile device 104 adjusted based on an estimated position of the first mobile device 102 relative to the second mobile device 104. The estimated position may be determined by the first mobile device 102, the second mobile device 104, and/or the like. For example, sensor data captured by either the first mobile device 102 or the second mobile device 104 may be used to estimate a distance from the first mobile device 102 to the second device 104 along a direction within the scene. Based on the sensor data and the location of the second mobile device 104, the external localization data may be generated to localize the first mobile device 102. In this manner, the second mobile device 104 may direct movement of the first mobile device 102 in an offline mode or in the presence of one or more perception issues experienced by the first mobile device 102.

The second mobile device 104 may capture the external motion data 108 as the second mobile device navigates along the travel path 106 separately but relative to the first mobile device 102 within the follow relationship. In an example where the second mobile device 104 is mounted to the first mobile device 102, the second mobile device 104 may capture the external motion data 108 as the first mobile device 102 and the second mobile device 104 move together along the travel path 106. The second mobile device 104 communicates the external motion data 108 to the first mobile device 102 as the second mobile device 104 moves along the travel path 106. Using the external motion data 108, the first mobile device 102 generates a motion plan 110 for autonomously moving along the travel path 106. In this manner, the perception issue may be temporarily resolved or otherwise addressed during movement of the first mobile device 102 from the current geographical location of the first mobile device 102 to the destination location by supplementing and/or replacing aspects of the motion data with the external motion data 108 for generating the motion plan 110.

In one implementation, the second mobile device 104 may be deployed to direct a plurality of mobile devices, including the first mobile device 102, to a common destination location or to a plurality of destination locations sharing at least a portion of the travel path 106. The second mobile device 104 may initiate the follow mode with each of the plurality of mobile devices, for example, in sequence based on the corresponding current geographical locations of each of the plurality of mobile devices. In this example, the follow mode may be initiated in response to the follow request, which may be scheduled or otherwise triggered. In connection with the follow mode, the external motion data 108 is communicated to each of the plurality of mobile devices based on a position of each of the plurality of mobile devices relative to the second mobile device 104. In one example, the external motion data 108 is communicated to each of the plurality of mobile devices and automatically adjusted based on the position of each of the plurality of mobile devices relative to the second mobile device 102 and/or the other mobile devices. In this manner, the second mobile device 104 may “pick-up” and direct the plurality of mobile devices together to a common destination location and/or along a shared portion of the travel path 106. For example, during a regularly scheduled maintenance or upgrade for the first mobile device 102 and other similar mobile devices, the second mobile device 104 may direct the plurality of mobile devices, including the first mobile device 102, to the destination location corresponding to the regularly scheduled maintenance or upgrade. In another example, the second mobile device 104 may direct a plurality of mobile devices including the first mobile device 102 to parking locations. At an entrance to a parking structure, the second mobile device 104 may initiate a follow mode with the first mobile device 102 and/or one or more additional mobile devices to direct the mobile devices into designated parking locations.

Similarly, the follow mode may be initiated for directing a fleet of mobile devices, including the mobile device 102, to the destination location, such as a storage or distribution location. The fleet may include at least the first mobile device 102 and a third mobile device directed by the second mobile device 104. However, it will be appreciated that any number of mobile devices may be in the follow mode with the second mobile device 104 leading. For example, the fleet of mobile devices may be involved in transport (e.g., long-haul tucks or semi-trucks for transporting items). The second mobile device 104 may be used to address perception issues with one or more mobile devices in the fleet of mobile devices or to otherwise direct the fleet of mobile devices along the travel path 106 to the destination location in response to the follow request. In this manner, a shipping or distribution may utilize the second mobile device 104 to collect and direct a fleet of mobile devices to the common destination location for distribution of items. Similarly, the follow request may correspond to moving items from the current geographical location to the destination location. The second mobile device 104 may be used to direct one or more mobile devices, including the first mobile device 102, to the destination location. A moving company may utilize the second mobile device 104 in this manner to direct one or more mobile devices containing items to the destination location. The user may prompt the follow request in connection with a move, and one or more mobile devices may be deployed to follow the second mobile device 104 in connection with the follow mode responsive to the follow request to move items to the destination location. The follow mode may be utilized in various contexts for the second mobile device 104 to direct movement of one or more mobile devices.

In one implementation, the second mobile device 104 is one of a plurality of mobile devices directing or otherwise assisting with movement of the first mobile device 102. For example, the travel path 106 from the current geographical location to the destination location may be generated. The travel path 106 may include a plurality of travel portions. At each travel portion, a mobile device within the vicinity of the first mobile device 102 and associated with the travel portion may be identified. The first mobile device 102 may initiate the follow mode with the corresponding mobile device for each portion of the travel path 106 with handoffs between mobile devices occurring as the first mobile device 102 moves along the travel path 106. In this manner, the first mobile device 102 may move to the destination location by following a plurality of mobile devices through use of the corresponding external motion data for generating the motion plan 110. It will be appreciated that the second mobile device 104 may be used to direct or otherwise assist movement of the first mobile device 102 in the follow mode in response to the follow request, including, but not limited to, circumstances in which the first mobile device 102 includes the perception issue.

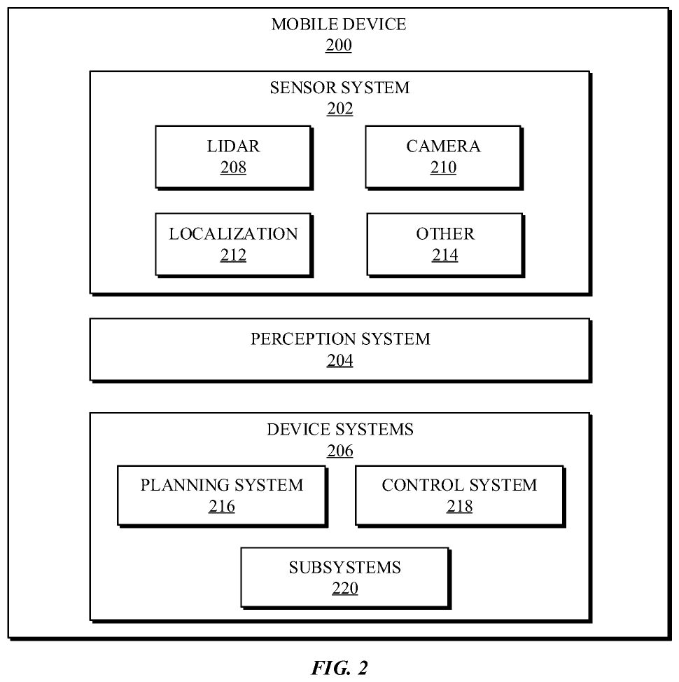

Turning to FIG. 2, an example mobile device 200, which may be the first mobile device 102 and/or the second mobile device 104, is shown. In one implementation, the mobile device 200 includes a sensor system 202, a perception system 204, and device systems 206.

The sensor system 202 includes one or more sensors configured to capture sensor data of the field of view of the mobile device 200, such as one or more images, localization data corresponding to a location, heading, orientation, and/or the like of the mobile device 200, movement data corresponding to motion of the mobile device 200, and/or the like. The one or more sensors may include 3D sensors configured to capture 3D images, 2D sensors configured to capture 2D images, RADAR sensors, infrared (IR) sensors, optical sensors, visual detection and ranging (ViDAR) sensors, and/or the like. For example, the one or more 3D sensors may include one or more LIDAR sensors 208 (e.g., scanning LIDAR sensors) or other depth sensors, and the one or more 2D sensors may include one or more cameras 210 (e.g., RGB cameras). These sensors may be referred to as perception sensors. The cameras 210 may capture color images, grayscale images, and/or other 2D images. One or more localization systems 212 may capture the localization data. The localization systems may include, without limitation, GNSS, inertial navigation system (INS), inertial measurement unit (IMU), global positioning system (GPS), altitude and heading reference system (AHRS), compass, accelerometer, and/or the like. Other sensors 214 may be used to capture sensor data, localization data, movement data, and/or the like.

The perception system 204 generates perception data, which may detect, identify, classify, and/or determine position of one or more objects using the sensor data. The perception data may be used by a planning system 216 in generating one or more actions for the mobile device 200, such as generating a motion plan having at least one movement action for autonomously moving the mobile device 200 through the field of view 108 based on the presence of objects. A control system 218 may be used to control various operations of the mobile device 200 in executing the motion plan. The motion plan may include various operational instructions for subsystems 220 of the mobile device 200 to autonomously execute to perform the movement action(s), as well as other action(s).

In one implementation, the sensor system 202, the perception system 204, and/or the planning system 216 of the first mobile device 102 may be experiencing the perception issue. The second mobile device 104 addresses the perception issue by initiating the follow mode, which provides the external motion data 108 for generating the motion plan for the first mobile device 102. The control system 218 and/or the subsystems 220 of the first mobile device 102 utilize the motion plan to autonomously move the first mobile device 102 from the current geographical location to the destination location.

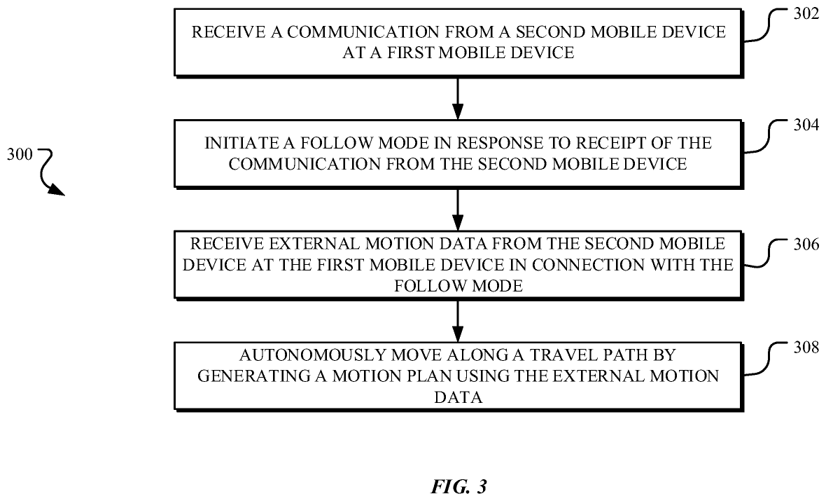

Referring to FIG. 3, example operations 300 are illustrated. In one implementation, an operation 302 receives a communication at a first mobile device from a second mobile device. The first mobile device may be a vehicle. The second mobile device is disposed in a vicinity of a current geographical location of the first mobile device, and the first mobile device experiencing a perception issue. The perception issue may include a sensor data capture issue, a perception data generation issue, localization issue, planning issue, and/or the like. The second mobile device may be deployed to the current geographical location of the first mobile device in response to a follow request from the first mobile device. The follow request may be communicated from the first mobile device in response to detection of the perception issue. The follow request may be received the second mobile device, a central server, and/or the like. The central server may deploy the second mobile device to the current geographical location of the first mobile device in response to the follow request. The second mobile device may be mounted to the first mobile device.

An operation 304 initiates a follow mode in response to receipt of the communication from the second mobile device at the first mobile device. The follow mode corresponds to a travel path from the current geographical location of the first mobile device to a destination location. The destination location may be a maintenance location, a storage location, a parking location, a charging location, a home location, and/or the like. The first mobile device may be one of a plurality of mobile devices in the follow mode with the second mobile device.

An operation 306 receives external motion data from the second mobile device at the first mobile device in connection with the follow mode. The external motion data is obtained by the second mobile device as the second mobile device moves along the travel path. An operation 308 autonomously moves the first mobile device along the travel path by generating a motion plan using the external motion data.

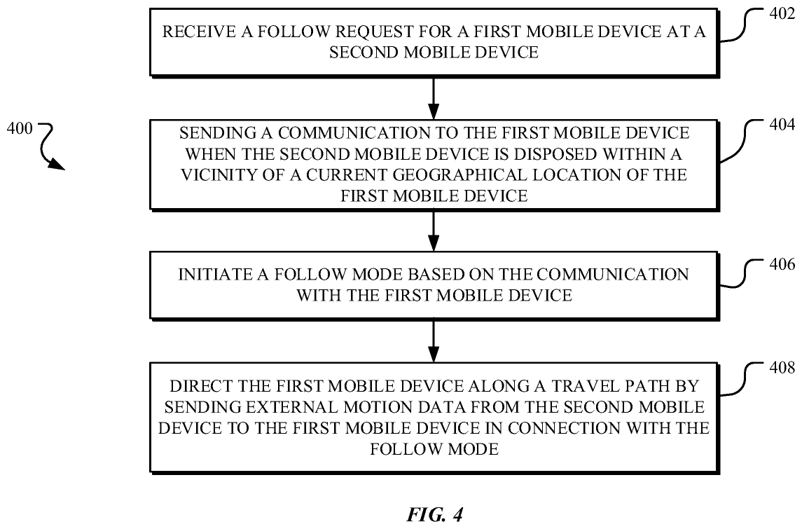

Turning to FIG. 4, example operations 400 are illustrated. In one implementation, an operation 402 receives a follow request for a first mobile device at a second mobile device. The follow request corresponds to a maintenance issue of the first mobile device. The maintenance issue may include a perception issue, an upgrade, a hardware issue, a software issue, and/or the like. The follow request may be received from at least one of the first mobile device or a central server. The follow request may be one of a plurality of follow requests, and the first mobile device may be one of a plurality of mobile devices. The second mobile device may be automatically deployed to the first mobile device.

An operation 404 sends a communication to the first mobile device when the second mobile device is disposed in a vicinity of a current geographical location of the first mobile device. An operation 406 initiates a follow mode based on the communication with the first mobile device. The follow mode corresponds to a travel path from the current geographical location of the first mobile device to a destination location. An operation 408 directs the first mobile device along the travel path by sending external motion data from the second mobile device to the first mobile device in connection with the follow mode. The external motion data may include external sensor data, external perception data, external motion planning data, and/or the like. The external motion data is obtained by the second mobile device as the second mobile device moves along the travel path. The first mobile device autonomously moves along the travel path by generating a motion plan using the external motion data.

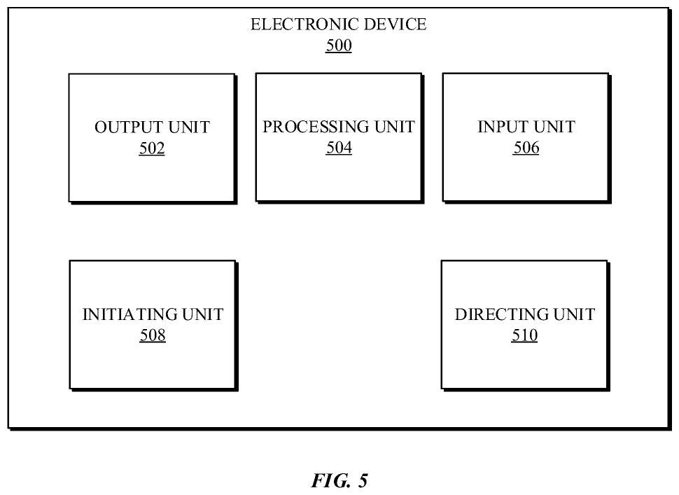

Turning to FIG. 5, an electronic device 500 including operational units 502-510 arranged to perform various operations of the presently disclosed technology is shown. The operational units 502-510 of the device 500 are implemented by hardware or a combination of hardware and software to carry out aspects of the present disclosure. It will be understood by persons of skill in the art that the operational units 502-510 described in FIG. 5 may be combined or separated into sub-blocks to implement the principles of the present disclosure. Therefore, the description herein supports any possible combination or separation or further definition of the operational units 502-510.

In one implementation, the electronic device 500 includes a processing unit 504 in communication with an output unit 502 and an input unit 506. The output unit 502 is configured to output (e.g., transmit, send, display, etc.) data, and the input unit 506 is configured to receive data from one or more input devices or systems. Various operations described herein may be implemented by the processing unit 504 using data received by the input unit 506 to output data using the output unit 502.

Additionally, in one implementation, the electronic device 500 includes units implementing the operations described with respect to FIG. 4. For example, the operations 402-404 may be implemented by the input unit 506 and the output unit 502, respectively. The operations 406-408 may be implemented by an initiating unit 508 and a directing unit 510, respectively. Each of these units may execute the corresponding operations with one or more computing units. In some implementations, a controlling unit implements various operations for controlling the operation of a vehicle based on the operations implemented by the units 502-510.

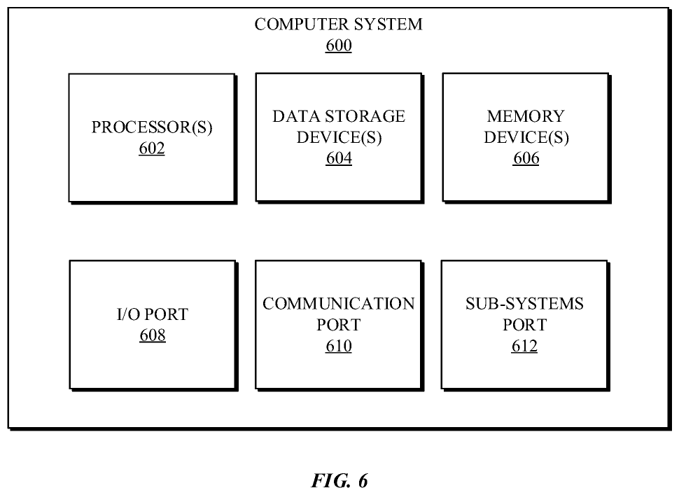

Referring to FIG. 6, a detailed description of an example computing system 600 having one or more computing units that may implement various systems and methods discussed herein is provided. The computing system 600 may be applicable to the measuring system 102 and other computing or network devices. It will be appreciated that specific implementations of these devices may be of differing possible specific computing architectures not all of which are specifically discussed herein but will be understood by those of ordinary skill in the art.

The computer system 600 may be a computing system is capable of executing a computer program product to execute a computer process. Data and program files may be input to the computer system 600, which reads the files and executes the programs therein. Some of the elements of the computer system 600 are shown in FIG. 6, including one or more hardware processors 602, one or more data storage devices 604, one or more memory devices 606, and/or one or more ports 608-612. Additionally, other elements that will be recognized by those skilled in the art may be included in the computing system 600 but are not explicitly depicted in FIG. 6 or discussed further herein. Various elements of the computer system 600 may communicate with one another by way of one or more communication buses, point-to-point communication paths, or other communication means not explicitly depicted in FIG. 6.

The processor 602 may include, for example, a central processing unit (CPU), a microprocessor, a microcontroller, a digital signal processor (DSP), and/or one or more internal levels of cache. There may be one or more processors 602, such that the processor 602 comprises a single central-processing unit, or a plurality of processing units capable of executing instructions and performing operations in parallel with each other, commonly referred to as a parallel processing environment.

The computer system 600 may be a conventional computer, a distributed computer, or any other type of computer, such as one or more external computers made available via a cloud computing architecture. The presently described technology is optionally implemented in software stored on the data stored device(s) 604, stored on the memory device(s) 606, and/or communicated via one or more of the ports 608-612, thereby transforming the computer system 600 in FIG. 6 to a special purpose machine for implementing the operations described herein. Examples of the computer system 600 include personal computers, servers, purpose-built autonomy processors, terminals, workstations, mobile phones, tablets, laptops, and the like.

The one or more data storage devices 604 may include any non-volatile data storage device capable of storing data generated or employed within the computing system 600, such as computer executable instructions for performing a computer process, which may include instructions of both application programs and an operating system (OS) that manages the various components of the computing system 600. The data storage devices 604 may include, without limitation, magnetic disk drives, optical disk drives, solid state drives (SSDs), flash drives, and the like. The data storage devices 604 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 604 and/or the memory devices 606, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 600 includes one or more ports, such as an input/output (I/O) port 608, a communication port 610, and a sub-systems port 612, for communicating with other computing, network, or vehicle devices. It will be appreciated that the ports 608-612 may be combined or separate and that more or fewer ports may be included in the computer system 600.

The I/O port 608 may be connected to an I/O device, or other device, by which information is input to or output from the computing system 600. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 600 via the I/O port 608. Similarly, the output devices may convert electrical signals received from computing system 600 via the I/O port 608 into signals that may be sensed as output by a human, such as sound, light, and/or touch. The input device may be an alphanumeric input device, including alphanumeric and other keys for communicating information and/or command selections to the processor 602 via the I/O port 608. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 600 via the I/O port 608. For example, an electrical signal generated within the computing system 600 may be converted to another type of signal, and/or vice-versa. In one implementation, the environment transducer devices sense characteristics or aspects of an environment local to or remote from the computing device 600, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 600, such as, physical movement of some object (e.g., a mechanical actuator), heating or cooling of a substance, adding a chemical substance, and/or the like.

In one implementation, a communication port 610 is connected to a network by way of which the computer system 600 may receive network data useful in executing the methods and systems set out herein as well as transmitting information and network configuration changes determined thereby. Stated differently, the communication port 610 connects the computer system 600 to one or more communication interface devices configured to transmit and/or receive information between the computing system 600 and other devices by way of one or more wired or wireless communication networks or connections. Examples of such networks or connections include, without limitation, Universal Serial Bus (USB), Ethernet, Wi-Fi, Bluetooth®, Near Field Communication (NFC), cellular, and so on. One or more such communication interface devices may be utilized via the communication port 610 to communicate one or more other machines, either directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 610 may communicate with an antenna for electromagnetic signal transmission and/or reception. In some examples, an antenna may be employed to receive Global Positioning System (GPS) data to facilitate determination of a location of a machine, vehicle, or another device.

The computer system 600 may include a sub-systems port 612 for communicating with one or more systems related to a vehicle to control an operation of the vehicle and/or exchange information between the computer system 600 and one or more sub-systems of the vehicle. Examples of such sub-systems of a vehicle, include, without limitation, imaging systems, radar, LIDAR, motor controllers and systems, battery control, fuel cell or other energy storage systems or controls in the case of such vehicles with hybrid or electric motor systems, autonomous or semi-autonomous processors and controllers, steering systems, brake systems, light systems, navigation systems, environment controls, entertainment systems, and the like.

The present disclosure recognizes that the use of perception and motion data may be used to the benefit of users. Out of an abundance of caution, it is noted that entities implementing the present technologies should comply with established privacy policies and/or practices. These privacy policies and practices should meet or exceed industry or governmental requirements for maintaining the privacy and security of personal data. Moreover, users should be allowed to “opt in” or “opt out” of allowing a mobile device to autonomously navigate along the travel path by generating a motion plan using external motion data. Third parties can evaluate implementers to verify their adherence to established privacy policies and practices.

The system set forth in FIG. 6 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
receiving a communication at a first mobile device from a second mobile device, the second mobile device disposed in a vicinity of a current geographical location of the first mobile device, while the first mobile device is experiencing a perception issue;
in accordance with receiving the communication from the second mobile device, operating a follow mode at the first mobile device, the follow mode corresponding to a travel path from the current geographical location of the first mobile device to a destination location;
receiving, at the first mobile device, external motion data from the second mobile device in connection with the follow mode, the external motion data obtained by the second mobile device as the second mobile device moves along the travel path; and
autonomously moving the first mobile device along the travel path by generating a motion plan using the external motion data.

2. The method of claim 1, wherein the external motion data comprises data obtained using one or more perception sensors of the second mobile device.

3. The method of claim 1, further comprising:
detecting input at the first mobile device, the input requesting operation of the first mobile device in the follow mode, wherein requesting the operation of the first mobile device in the follow mode causes deployment of the second mobile device to the current geographical location of the first mobile device.

4. The method of claim 3, wherein the input requesting operation of the first mobile device in the follow mode is detected in accordance with detection of the perception issue.

5. The method of claim 1, wherein the destination location is at least one of maintenance location, a storage location, a parking location, a charging location, or a home location.

6. The method of claim 1, wherein the first mobile device is one of a plurality of vehicles in the follow mode with the second mobile device.

7. The method of claim 1, wherein the second mobile device mounts to the first mobile device.

8. The method of claim 1, wherein the perception issue includes one or more of, a sensor imaging issue, a sensor data capture issue, a perception data generation issue, and a motion planning issue.

9. A system comprising:
a sensor system having at least one sensor configured to capture sensor data corresponding to a field of view of a first mobile device;
a perception system configured to generate perception data using the sensor data, at least one of the sensor system or the perception system experiencing a perception issue, the first mobile device receiving a communication from a second mobile device disposed in the vicinity of a current geographical location of the first mobile device, the communication corresponding to the perception issue, a follow mode between the first mobile device and the second mobile device being initiated in accordance with receipt of the communication from the second mobile device, the follow mode corresponding to a travel path from the current geographical location of the first mobile device to a destination location;
a motion planner configured to receive external motion data from the second mobile device at the first mobile device in connection with the follow mode, the external motion data obtained by the first mobile device as the second mobile device moves along the travel path, the motion planner configured to generate a motion plan using the external motion data for autonomously moving the first mobile device along the travel path.

10. The system of claim 9, wherein the external motion data includes one or more of external sensor data, external perception data, and external motion planning data.

11. The system of claim 9, wherein the first mobile device is a vehicle.

12. The system of claim 9, wherein the first mobile device sends a follow request in accordance with detection of the perception issue.

13. The system of claim 12, wherein the follow request is received at one or more of the second mobile device or a central server.

14. The system of claim 13, wherein the central server deploys the second mobile device to the current geographical location of the first mobile device in response to the follow request.

15. One or more tangible non-transitory computer-readable storage media storing computer-executable instructions for performing a computer process on a computing system, the computer process comprising:
receiving a follow request for a first mobile device at a second mobile device, the follow request corresponding to a maintenance issue of the first mobile device;
sending a communication to the first mobile device when the second mobile device is disposed in a vicinity of a current geographical location of the first mobile device;
initiating a follow mode based on the communication with the first mobile device, the follow mode corresponding to a travel path from the current geographical location of the first mobile device to a destination location; and
directing the first mobile device along the travel path by sending external motion data from the second mobile device to the first mobile device in connection with the follow mode, the external motion data obtained by the second mobile device as the second mobile device moves along the travel path, the first mobile device autonomously moving along the travel path by generating a motion plan using the external motion data.

16. The one or more tangible non-transitory computer-readable storage media of claim 15, wherein the external motion data includes one or more of external sensor data, external perception data, and external motion planning data.

17. The one or more tangible non-transitory computer-readable storage media of claim 15, wherein the follow request comprises the current geographical location of the first mobile device, and wherein the computer process further comprises:
generating a route plan and movement plan; and
causing movement of the second mobile device towards the current geographical location, using the route plan and movement plan.

18. The one or more tangible non-transitory computer-readable storage media of claim 15, wherein the follow request is one of a plurality of follow requests and the first mobile device is one of a plurality of mobile vehicles.

19. The one or more tangible non-transitory computer-readable storage media of claim 15, wherein the follow request is received from at least one of the first mobile device or a central server.

20. The one or more tangible non-transitory computer-readable storage media of claim 15, wherein the maintenance issue includes a perception issue.
